(19) United States
(12) Patent Application Publication
(10) Pub. No.: US 2020/0360206 A1
(43) Pub. Date: Nov. 19, 2020

(54) Device and Kit for Upgrading a Residential Bed to Include an Equipment Support

(71) Applicant: Hill-Rom Services, Inc., Batesville, IN (US)

(72) Inventors: David Ribble, Indanapolis, IN (US); Kirsten Emmons, Batesville, IN (US); Craig Meyerson, Syracuse, NY (US); Ibne Soreefan, West Chester, OH (US)

(21) Appl. No.: 16/867,968

(22) Filed: May 6, 2020

Related U.S. Application Data
(60) Provisional application No. 62/848,817, filed on May 16, 2019.

(51) Int. Cl. A61G 7/015; A47C 20/04

(52) U.S. Cl. CPC A61G 7/015; A47C 20/04

(57) ABSTRACT

A mattress support includes a base plate having a free end and a hinged end and an upper plate having a free end and a hinged end. The hinged end of the upper plate is connected to the hinged end of the base plate by a hinge. The mattress support also includes an equipment support anchor at the free end of the base plate.

This application claims priority to U.S. Provisional Application 62/848,817 entitled “Device and Kit for Upgrading a Residential Bed to Include an Equipment Support” filed on May 16, 2019, the contents of which are incorporated herein by reference.

### RELATED APPLICATIONS

Each of the following is incorporated herein by reference in its entirety:
1) U.S. provisional application 62/739,334 filed on Sep. 30, 2018 and titled “PATIENT CARE SYSTEM FOR A HOME ENVIRONMENT”,
2) U.S. provisional application 62/739,337 filed on Sep. 30, 2018 and titled “STRUCTURES FOR CAUSING MOVEMENT OF ELEMENTS OF A BED”,
3) U.S. provisional application 62/739,340 filed on Sep. 30, 2018 and titled “MATTRESS SUPPORT FOR ADDING HOSPITAL BED FUNCTIONALITY TO AN AT-HOME BED”,
4) U.S. provisional application 62/739,344 filed on Sep. 30, 2018 and titled “MODULAR CONTROL SYSTEM FOR UPGRADING A BED TO INCLUDE MOVABLE COMPONENTS”,
5) U.S. provisional application No. 62/567,995 filed Oct. 4, 2017 titled “APPARATUS FOR ADDING HOSPITAL BED FUNCTIONALITY TO AN AT-HOME BED”,
6) U.S. provisional application No. 62/567,275 filed on Oct. 24, 2017 titled “MODULAR TURN ASSIST APPARATUS AND METHOD THEREFOR”,
7) U.S. Patent Application No. 62/847,431 filed on May 14, 2019 and entitled “Mattress Support for Imparting a Hospital Bed Functionality to a Consumer Bed”.

### TECHNICAL FIELD

The subject matter described herein relates to a device and a kit for adding a functionality to a residential bed which has heretofore been available only in connection with specially designed hospital beds. In particular this application describes a device and kit for adding an equipment support to a residential bed.

### BACKGROUND

Extended hospitalization of a patient is not always desirable. Among the reasons are expense, exposure to hospital acquired infections, and the possibility that the patient's frame of mind may suffer due to extended hospitalization and absence from his home environment. It is therefore advantageous to allow the patient to return home provided that adequate medical care can be provided in the home environment.

One impediment to allowing a patient to leave the hospital and return home is that his residential bed may not have functionalities that are necessary for his care because such functionalities are present only in specially designed hospital beds. As a result, the patient may remain in the hospital longer than necessary just to have the functionalities of a hospital bed at his disposal. While it is possible that the patient could rent a hospital bed for residential use, the rental fees may be more than the patient can afford.

Therefore, it is desirable to introduce into residential beds certain capabilities that are typically present only in hospital beds, and to do so in a way that is cost effective for the patient.

### SUMMARY

### Brief Description of the Drawings

The foregoing and other features of the various embodiments of the device and kit described herein will become more apparent from the following detailed description and the accompanying drawings in which:

FIG. 1 is a schematic side elevation view of a residential bed including a mattress, and also showing a head end mattress support and a foot end mattress support, the mattress being in a planar configuration or profile.

FIG. 2 is a view similar to FIG. 1 showing the mattress in a nonplanar configuration due to actuation of the head end mattress support and foot end mattress support.

FIG. 3 is a perspective view of a modularized embodiment of the head end mattress support.

FIG. 4A is a side elevation view of a residential bed, an equipment support, and a head end mattress support having a base plate and an anchor for the equipment support, the anchor being in the form of a cup.

FIG. 4B is a plan view of the base plate and anchor of the mattress support of FIG. 4A with the equipment support not shown.

FIG. 4C is a plan view similar to that of FIG. 4B with the equipment support shown.

FIGS. 5A and 5B are views similar to FIGS. 4A and 4B in which the anchor is in the form of a sleeve.

FIGS. 6A-6B are side elevation and plan views of a portion of a mattress support showing an embodiment in which the anchor is a pair of plates.

FIGS. 7A, 7B and 7C are a side elevation view, a plan view, and an end elevation view of a mattress support having an anchor in the form of multiple anchor elements and also showing an equipment support with a trifurcated mast.

FIGS. 8A and 8B are views similar to FIGS. 6A and 6B in which the anchor is a mounting pad.

FIGS. 9A and 9B are views similar to FIGS. 6A and 6B in which the anchor is a tongue and the equipment support includes a bulge whose upper surface rests on the tongue.

FIG. 10 is a view similar to FIG. 6A in which the anchor is a shackle.

FIG. 11A is a side elevation view of a bed and a head end mattress support which includes a strap assembly comprised of three unitary straps that wrap around a bed frame.

FIG. 11B is a view in direction 11B-11B of FIG. 11A rotated 90 degrees clockwise.

FIGS. 12A, 12B, and 12C are an end elevation view, an enlargement of a portion of FIG. 12A and a plan view of a mattress support including a lashing ring and a strap assembly comprised of one unitary strap having a buckle.

FIG. 12D is a view similar to FIG. 12B in which the buckle is a component of the mattress support in lieu of the lashing ring.

FIG. 13 is a view similar to FIG. 12A in which the strap assembly is a single nonunitary strap which includes a first strap segment and a second strap segment, the segments joined together by a turnbuckle.

FIG. 14 is a view similar to FIG. 13 in which the strap assembly is a single nonunitary strap which includes a first strap segment and a second strap segment, and also showing a bed frame having a strap segment attachment and tensioning feature which acts to join the first strap segment to the second strap segment.

FIGS. 15A, 15B, 16A, 16B, 16C, 16D, 17, and 18 are views similar to FIGS. 11A, 11B, 12A, 12B, 12C, 12D, 13, and 14 respectively in which the mattress support is augmented by a support plate having a second anchor.

FIG. 19 is a schematic side elevation view showing a head end equipment support and a foot end equipment support, a head end mattress support with an anchor which supports the head end equipment support and a foot end mattress support with an anchor which supports the foot end equipment support.

FIG. 20 is a view similar to FIG. 19 in which the head end mattress support and the foot end mattress support cooperate to support an equipment support that spans the length of the bed.

FIG. 21 is a plan view in which the head end mattress support and the foot end mattress support cooperate to support an equipment support that spans the length of the bed and which includes a single longitudinally extending beam.

FIG. 22 is a plan view similar to FIG. 21 in which the equipment support includes multiple longitudinally extending beams.

FIG. 23 a plan view similar to that of FIGS. 21 and 22 in which the equipment support includes two beams, four masts and a crossbar 258 extending between the beams.

### DETAILED DESCRIPTION

The present invention may comprise one or more of the features recited in the appended claims and/or one or more of the following features or combinations thereof.

In this specification and drawings, features similar to or the same as features already described may be identified by reference characters or numerals which are the same as or similar to those previously used. Similar elements may be identified by a common reference character or numeral, with suffixes being used to refer to specific occurrences of the element.

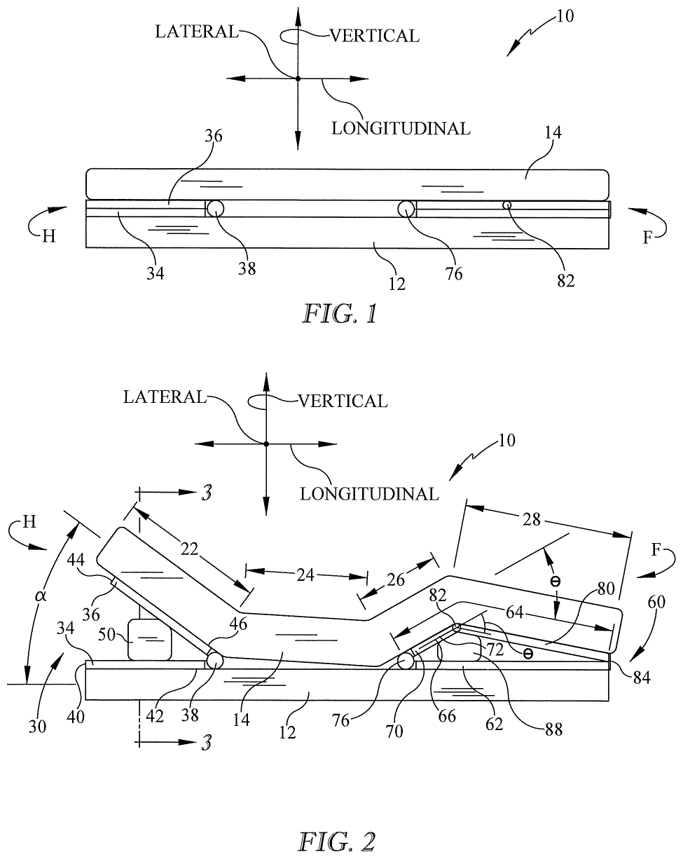

Referring to FIGS. 1 and 2, an illustrative bed assembly 10 extends longitudinally from a head end H to a foot end F and laterally from a left side (not visible in FIGS. 1-2) to a right side (in the plane of FIGS. 1-2). The bed assembly includes a frame 12 and a mattress 14 supported on the frame. The mattress has an upper body or torso section 22 corresponding approximately to the torso and head of a supine occupant of the mattress, a seat section 24 corresponding approximately to the occupant's buttocks, a thigh section 26 corresponding approximately to the occupant's thighs, and a calf section 28 corresponding approximately to the occupant's calves and feet. The bed assembly as just described is a residential bed assembly of the type readily available to consumers for use in their homes.

FIGS. 1-2 also show a head end mattress support 30. The head end mattress support is not a component of the residential bed assembly described above. The head end mattress support is positionable between the head end of the frame 12 and the head end of the mattress 14, and is shown as so positioned in FIGS. 1 and 2.

The head end mattress support includes a base plate 34 having a free end 40 and a hinged end 42. The head end mattress support also includes an upper plate 36 having a free end 44 and a hinged end 46. A hinge 38 connects hinged end 46 of the upper plate to hinged end 42 of the base plate. The head end mattress support also includes an elevation system 50 between the base plate and the upper plate. The illustrated elevation system is a bladder array 50. The elevation system may be embodied in other ways, some of which are disclosed in U.S. Provisional Patent Application 62/847,431 entitled “Mattress Support for Imparting a Hospital Bed Functionality to a Consumer Bed” filed on May 14, 2019.

In operation, elevation system 50 may be used to raise and lower (i.e. change the orientation angle α of) the head end portion of the mattress. In embodiments in which the elevation system is a bladder array, the bladder array is inflated/deflated (pressurized/depressurized) to raise/lower the head end portion of the mattress. The pressurizing medium is typically compressed air. The head end mattress support therefore adds to a residential bed a functionality usually found only in specially designed hospital beds, namely adjustability of the angle α of the torso section of the mattress. A patient who requires this functionality, but who does not need to be hospitalized, can therefore achieve the functionality in his residential bed at a modest cost.

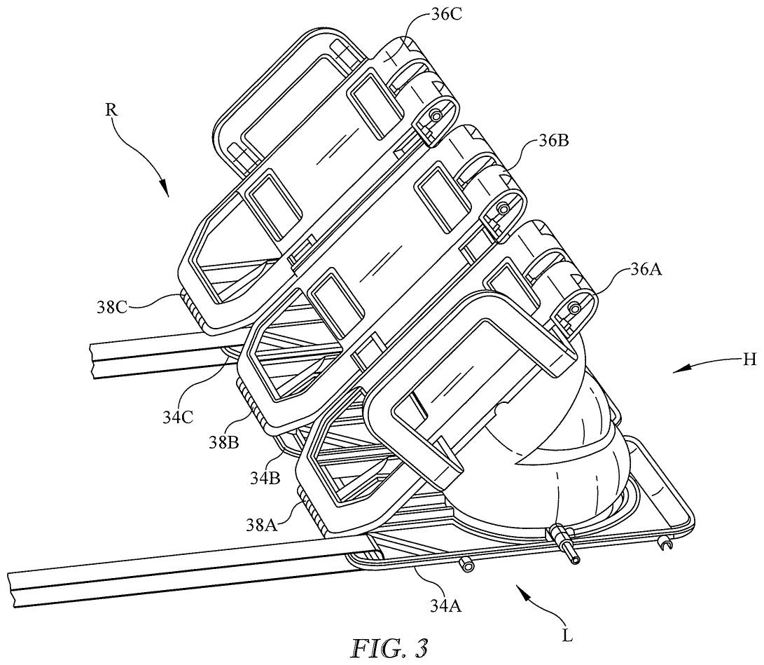

Referring to FIG. 3 the base plate and upper plate of the head end mattress support may be laterally segmented or modularized. Unlike FIGS. 1-2 in which the base plate is a single plate and the upper plate is also a single plate, the base plate of the embodiment of FIG. 3 is multiple base plates (or base plate modules), and the upper plate of the embodiment of FIG. 3 is multiple upper plates (or upper plate modules), specifically three plates which are laterally linked together. As is evident from the foregoing, the phrase “base plate” encompasses a single base plate as well multiple, laterally distributed base plates (or base plate modules) linked together. Similarly “upper plate” encompasses a single upper plate or multiple, laterally distributed upper plates (or upper plate modules) linked together.

The modular construction of FIG. 3 permits the mattress support to be customized so that it can be used with residential beds having different widths. A narrow bed requires fewer modules; a wider bed requires more modules. The modules are constructed so that they can be easily assembled to each other. Further description of the modularization can be found in U.S. Provisional Application 62/739,344.

FIGS. 1-2 also show one embodiment of a foot end mattress support 60. The foot end mattress support is not a component of the residential bed assembly described above. The foot end mattress support is described in more detail in U.S. Provisional Patent Application No. 62/847,431 filed on May 14, 2019 and entitled “Mattress Support for Imparting a Hospital Bed Functionality to a Consumer Bed”. The foot end mattress support includes a base plate 62 and an upper plate 64. The upper plate is an assembly which includes a head plate 66 having a head end 70 and a foot end 72. Head end 70 is hinged to base plate 62 by a first hinge 76. The upper plate assembly also includes a foot plate 80 in tandem with head plate 66. The foot plate is hinged to the foot end of the head plate by a second hinge 82. Second hinge 82 is substantially parallel to first hinge 76 (i.e. the axis of rotation of each hinge is perpendicular to the plane of FIGS. 1 and 2). Hinges 76, 82 may be of any suitable design. Examples include pin and knuckle hinges and living hinges.

The foot end mattress support also includes an actuator system 88 between the base plate and the upper plate assembly. The actuator system is analogous to the elevation system 50 described above in connection with the head end mattress support. The actuator system is operable to adjust the upper plate assembly 64 on order to change angle θ defined by the thigh and calf sections of the mattress. The actuator system may take various forms including one or more bladder arrays 50 as seen in FIG. 2.

Another feature which may be useful to incorporate into a residential bed is a structural support or framework, a portion of which is vertically spaced from the mattress. Such frameworks go by various names such as patient helper, traction support frame, raising device, lifting device, and fracture frame, depending in part on the intended use of the device. The common theme of such devices is their ability to support a load such as part of the patient's weight or the weight of equipment used to care for the patient. Examples of known frameworks are given in the following US Patent Documents: U.S. Pat. Nos. 4,202,062, 4,253,207, 4,340,984, 4,593,422, 4,847,930, 4,932,090, 5,836,026, 6,141,806, 6,216,293, 6,240,583, and 6,397,416. In this specification the analogue of such devices is referred to as an equipment support. Therefore, “equipment support” as used in this specification includes devices that support equipment, devices that support at least a portion of the patient's weight, and devices that support both equipment and at least a portion of the patient's weight.

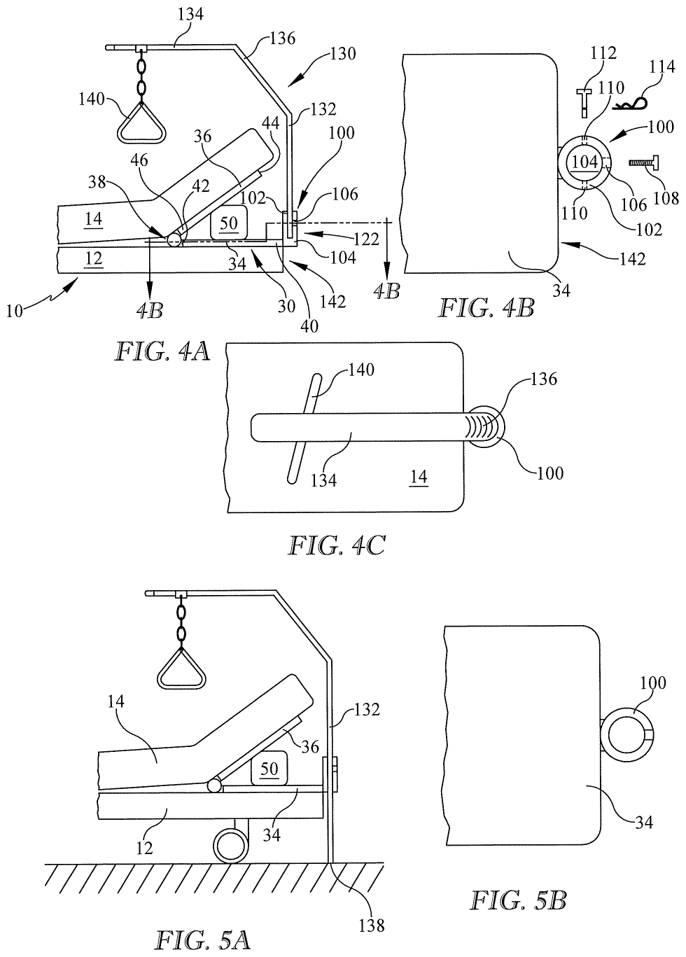

Referring to FIGS. 4A-4C a head end mattress support 30 includes an anchor 100 for an equipment support 130 at the free end 40 of base plate 34. The illustrated equipment support has a vertically extending mast 132, a horizontally extending beam 134 and an elbow 136 joining the mast to the beam. Numerous other designs are possible. As with the base plate and upper plate of the head end mattress support of FIGS. 1-2, the base plate and upper plate of the head end mattress support of FIGS. 4A-4C may be laterally segmented or modularized as seen in FIG. 3.

FIGS. 4A and 4C also show a “trapeze” 140 suspended from support beam 134. The trapeze is one example of an item of equipment that can be supported by the equipment support. The trapeze is useful for assisting with patient mobility. For example a patient who wishes to change from a supine posture to a sitting posture can grasp the trapeze and pull on it to assist him with changing his posture. In that example the equipment support also bears at least a portion of the patient's weight.

The anchor of FIGS. 4A-4C is a cup 100 having a cylindrical wall 102 and a bottom 104. The bottom of mast 132 rests on the bottom of the cup. The inner diameter of the cup wall is approximately equal to the outer diameter of mast 132 so that the mast can be conveniently inserted into and removed from the cup, but is nevertheless held snugly by the cup to minimize wobbling of the mast. The cup may be formed integrally with the base plate 34 or may be a component manufactured independently of the base plate and affixed to the base plate in any suitable way, for example by welding.

Like the head end mattress support of FIGS. 1-3 the head end mattress support of FIGS. 4A-4C is adapted to be inserted between a bed frame 12 and a mattress 14. When so inserted, anchor 100 is accessible from a longitudinal end of the bed. In one embodiment the anchor is accessible because it projects longitudinally beyond the longitudinal end 142 of the mattress. In FIGS. 4A-4C the longitudinal end of the mattress beyond which the anchor projects is the head end.

The illustrated cup 100 includes a threaded hole 106. Once the mast is inserted in the cup a screw 108 may be installed in the hole and torqued sufficiently to resist removal of the mast from the cup and to take up any “slop” between the inner diameter of the cup and the outer diameter of the mast. Other securement arrangements may also be employed such as a screw that extends into a companion hole in the mast, a screw that extends completely through the mast and into another threaded hole in the cup which is 180 degrees from hole 106. In another variant the cup includes unthreaded holes 110 (at the twelve o'clock and three o'clock locations as seen in FIG. 4B). The mast includes corresponding holes, not illustrated. After the mast is inserted in the cup a hitch pin 112 is installed through the four holes, and a hitch pin clip 114 is installed on the hitch pin to guard against unintended removal of the hitch pin. The hitch pin and hitch pin clip are shown in an unassembled state in FIG. 4B.

FIGS. 5A-5B show another embodiment of an anchor similar to that of FIGS. 4A-4C. The anchor is a bottomless cylindrical sleeve 100. Bottom end 138 of mast 132 rests on the floor. The securement arrangements described in connection with the cup embodiment of FIGS. 4A-4C apply to the sleeve embodiment. In another embodiment the securement arrangement is such that the foot end of the mast does not rest on the floor.

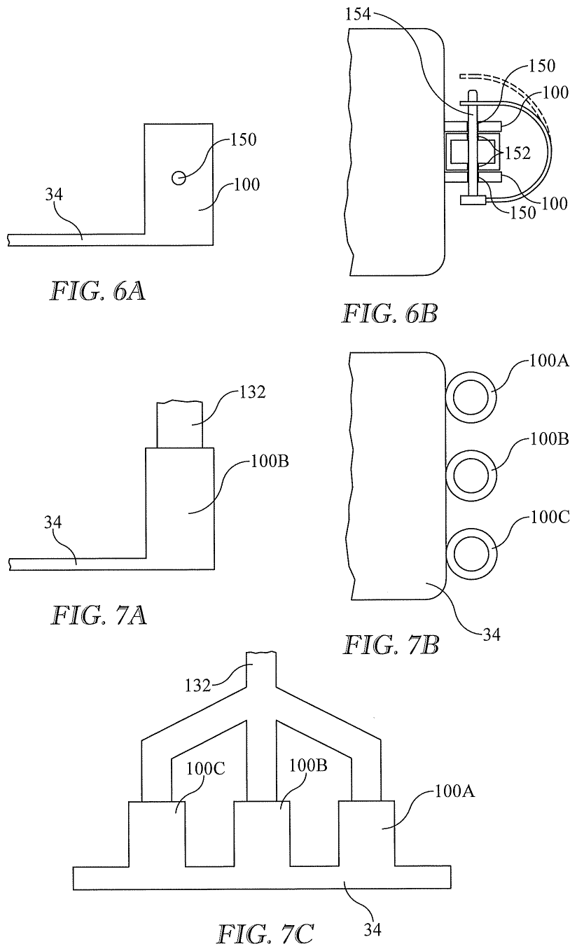

FIGS. 6A-6B show an embodiment in which the anchor is a pair of plates 100 each having a hole 150. The equipment support mast includes corresponding holes 152. The mast is slid horizontally into the interplate space. A wire lock clevis pin 154 is installed in the holes.

FIGS. 7A-7C show an embodiment in which anchor 100 is a set of laterally distributed anchor elements, and the lower end of the mast is trifurcated.

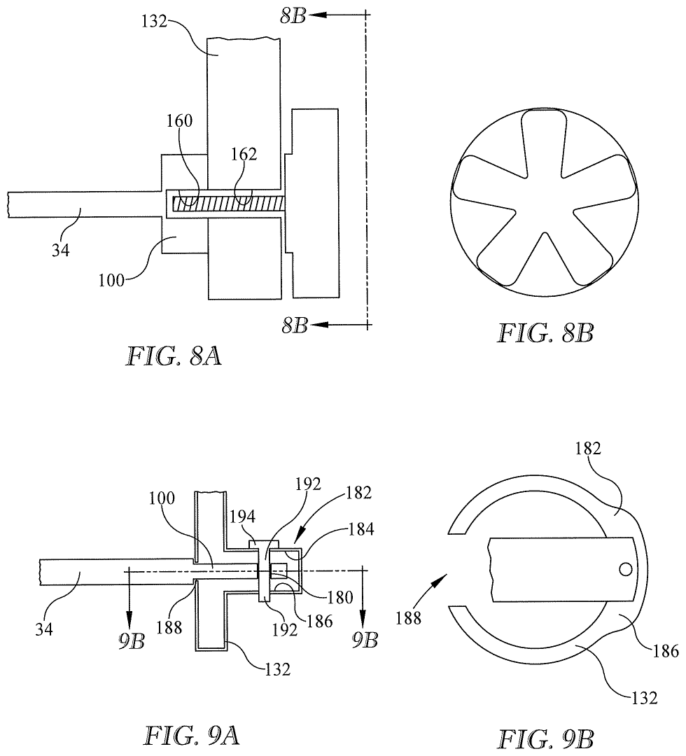

FIGS. 8A-8B show an embodiment in which the anchor is a mounting pad 100 having a threaded hole 160. Mast 132 includes a corresponding threaded hole 162. A screw 164 is installed through the holes to secure the mast to the base plate. The illustrated screw is a knob with a threaded shank 116 and a large diameter handle 168 so that a user can easily install and remove the knob without the use of tools and without requiring the user to possess undue strength.

FIGS. 9A-9B show an embodiment in which the anchor is a horizontally extending tongue 100 with a hole 180. The hollow mast includes a localized bulge 182 having upper and lower surfaces 184, 186, and a slot 188 180 degrees opposite the bulge. Holes 192 penetrate through vertically opposite sides of the bulge and register with tongue hole 180. A connector such as a pin or screw 194 extends through the holes 180, 192.

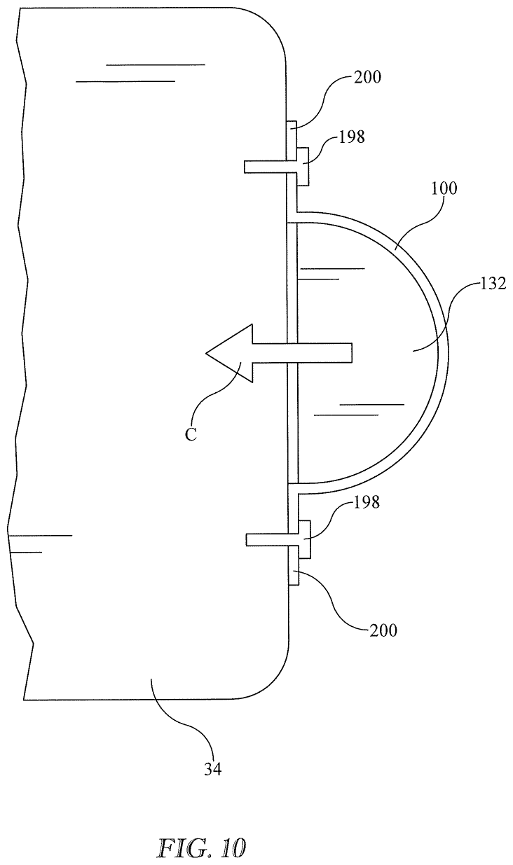

FIG. 10A shows an embodiment in which the anchor is a shackle 100. Screws 198 pass through holes in flanges 200 of the shackle to secure the shackle to the base plate 34 and trap mast 132 horizontally. Mast 132 has a semicircular cross sectional profile. Other arrangements may be included to trap the mast vertically if the clamping force C exerted by the shackle on the mast is not adequate to resist vertical movement of the shackle. Alternatively the bottom of the mast may rest on the floor as in the embodiment of FIGS. 5A-5B.

Applicability of the various securement arrangements described above (screws, plain pins, knobs, hitch pins, clevis pins) is not necessarily limited to the embodiment(s) in connection with which the securement arrangement is shown. Rather, many of the securement arrangements shown in connection with one embodiment can be used with other embodiments.

Mast 132 may be solid or hollow and may have any cross sectional profile which is structurally satisfactory and which is compatible with the anchor. Beam 134 and elbow 136 may also be solid or hollow.

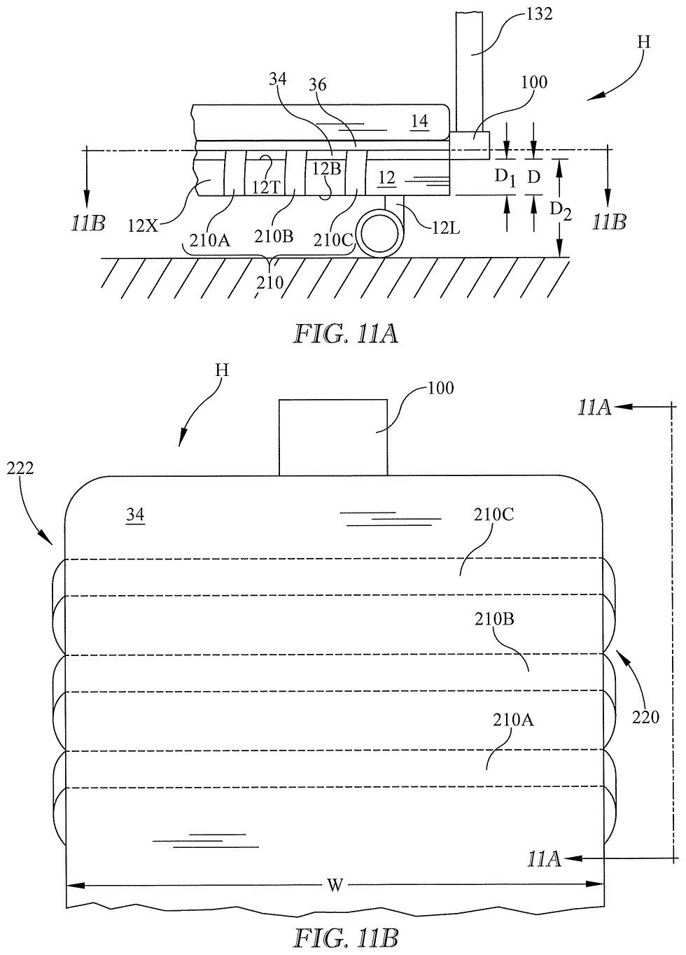

Before proceeding it should be noted that upper plate 36 and elevation system 50 are not shown in FIGS. 11B-14 and FIGS. 15B-19 in order to not introduce unnecessary clutter into the drawings.

Referring to FIGS. 11A-11B, the mattress support may also include a tether assembly 210. The tether assembly described and illustrated herein is in the form of a strap assembly and is therefore referred to as a strap assembly. However the tether assembly may take other forms, such as a cable or set of cables. Therefore “strap assembly” and “strap”, as used herein, should be interpreted as referring to a tether that need not be in the form of a strap. The illustrated strap assembly includes three longitudinally distributed straps 210A, 210B, 210C, however the strap assembly may have more or fewer straps, including only one strap. Each strap of the strap assembly of FIGS. 11A-11B is referred to herein as a unitary strap because it is nonsegmented. By contrast, a nonunitary strap is one that includes at least first and second strap segments used in conjunction with each other at substantially the same longitudinal location on the bed.

Each strap of FIGS. 11A-11B is permanently or removably attached to a first lateral side 220 of base plate 34. Alternatively the strap might not be attached to the first lateral side of the base plate but is nevertheless attachable to the first lateral side of the base plate.

Each strap is also permanently or removably attached to a second lateral side 222 of base plate 34. Alternatively the strap might not be attached to the second lateral side of the base plate but is nevertheless attachable to the second lateral side of the base plate.

In use, each strap of the strap assembly wraps around three sides of the frame (the lateral left side, the bottom side, and the lateral right side). That is, each strap extends from one side of base plate 34, down along the same side of frame 12, laterally across the bottom side 12B of the frame, up the opposite lateral side of the frame, and to the other side of the base plate. The strap assembly helps keep the base plate, and therefore the entire head end mattress support, in place laterally and longitudinally.

Each strap has a length which is at least as long as the width W of the base plate. As a practical matter, the length of each strap is at least as long as the width W of the base plate plus two times the depth D of the frame. Depth D is determined by the vertical separation between the frame top surface 12T and the frame bottom surface 12B along which the strap extends laterally. For example in FIG. 11A the frame includes a box 12X and legs 12L, only one of which is visible. Frame depth D is dimension D₁ of the box, not dimension D₂, because the straps extend laterally across the bottom surface of the box, not underneath the legs.

Also as a practical matter, a unitary strap which is permanently attached to one lateral side of base plate 34 will not be permanently attached to the other lateral side of the base plate. Instead, it will be unattached to the other side of the base plate or removably attached to the other side of the base plate. This arrangement results in the unattached or nonpermanently attached end of the strap being a “free” end. A user can easily pass the free end underneath the frame to the other side of the frame and then attach (or re-attach) the free end to the other lateral side of the base plate.

In order to serve its purpose of keeping the head end mattress support in place laterally and longitudinally, the mattress support may also include a strap tensioner. The strap tensioner is used to ensure that the straps of the strap assembly are cinched tightly enough around the frame to keep the head end mattress support in place laterally and longitudinally.

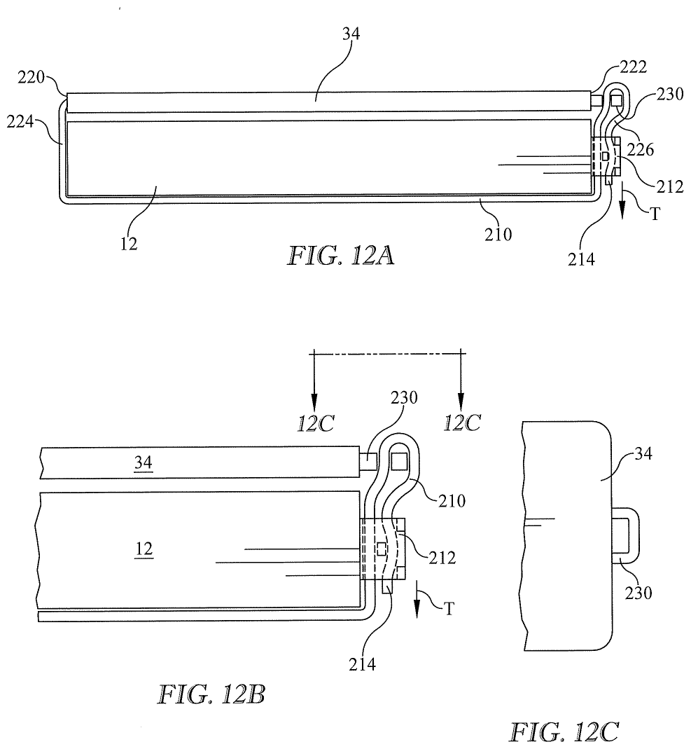

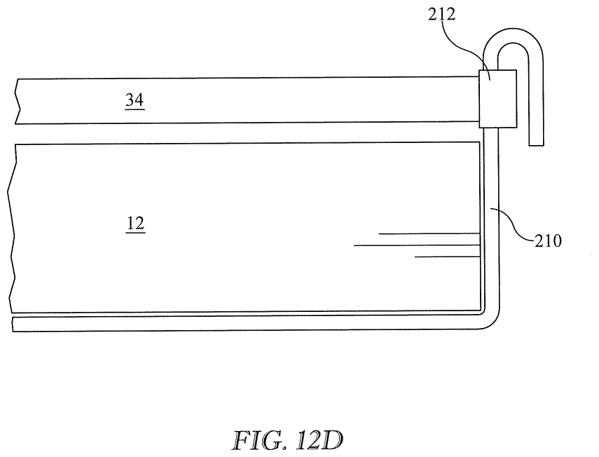

FIGS. 12A-12C show an embodiment of a strap assembly, embodied as a single, unitary strap 210, and a strap tensioner 212. The strap has a first end 224 attached or attachable to a first lateral side 220 of base plate 34, and a second end 226 attached or attachable to a second lateral side 222 of the base plate at a lashing ring 230. The strap is adapted to extend underneath bed frame 12 from the first lateral side of the base plate to the second lateral side of the base plate. The tensioner is in the form of a “one-way” buckle on the strap. The free end of the strap passes easily through the buckle in a direction T for tightening the strap. The strap cannot easily pass through the buckle in the other direction unless a user intentionally releases the buckle's grip on the strap.

FIGS. 12A and 12B also illustrate the point that the word “end”, when used to describe the portion of the strap which is attached to the base plate, need not be the absolute extremity 214 of the strap. Instead it may be a portion of the strap which is remote from the other end of the strap and which engages with the base plate (e.g. at lashing ring 230).

Referring to FIG. 12D, the one-way buckle could be a part of the base plate (in lieu of lashing ring 230) instead of part of the strap.

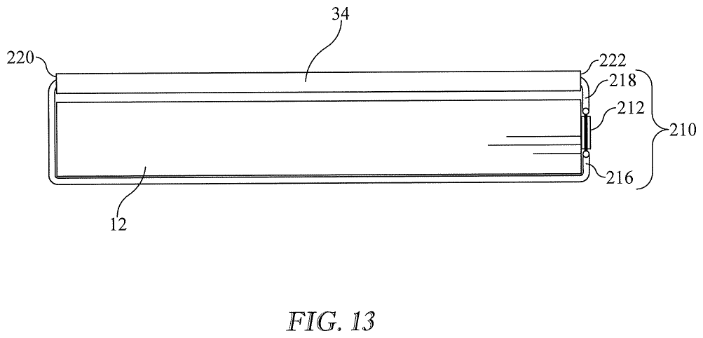

FIG. 13 shows an embodiment in which strap assembly 210, once again embodied as a single strap, is a nonunitary strap which includes a first strap segment 216 attached (permanently or removably) or attachable to a first lateral side 220 of base plate 34 and a second strap segment 218 attached (permanently or removably) or attachable to a second lateral side 222 of the base plate. The strap segments are designed to be in series with each other, i.e. they are designed to be used at substantially the same longitudinal location along the length of the bed. The first strap segment is relatively long, and passes underneath frame 12. The second strap segment is relatively short and hangs down along the second side of the frame. Strap segments 216, 218 are connected to each other. The illustrated segments are connected to each other by reason of each being connected to a common component, i.e. tensioner 212. The tensioner is a turnbuckle 212 which may be a part of the first strap segment or a part of the second strap segment or may be a separate component which is connectable to the strap segments. A user tightens the turnbuckle to tension the strap or untightens the turnbuckle to detension the strap.

One difference between the nonunitary strap embodiment of FIG. 13 and the unitary strap embodiment of FIG. 12 is that both strap segments of the nonunitary embodiment can be permanently attached to their respective lateral sides of base plate 34. Each strap segment has a free end that can be connected to the free end of the other strap segment by, for example, turnbuckle 212.

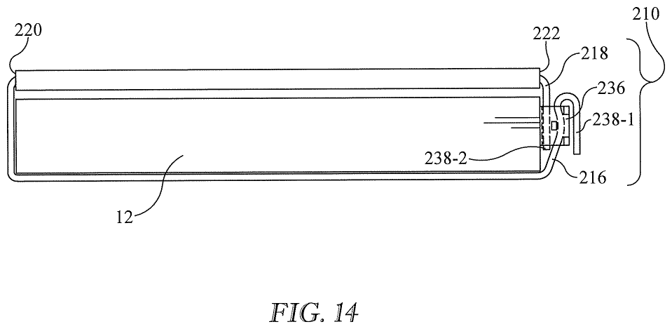

FIG. 14 shows another embodiment in which the strap assembly is embodied as a single nonunitary strap. The strap includes a first strap segment 216 attached or attachable to a first lateral side 220 of base plate 34, and a second strap segment 218 attached or attachable to a second lateral side 222 of the base plate 34. The bed frame 12 includes a strap segment connector and tensioning feature 236. One example of a suitable feature is the one-way buckle of FIGS. 12B and 12D. The strap segments are adapted to be attached to or attachable to the bed frame, e.g. to connector and tensioning feature 236. A user inserts the free ends 238-1, 238-2 of each strap segment through the connector and tensioning feature to cinch the strap assembly tightly around bed frame 12. The connector and tensioning feature may be a part of the bed frame or may be an add-on item sold separately.

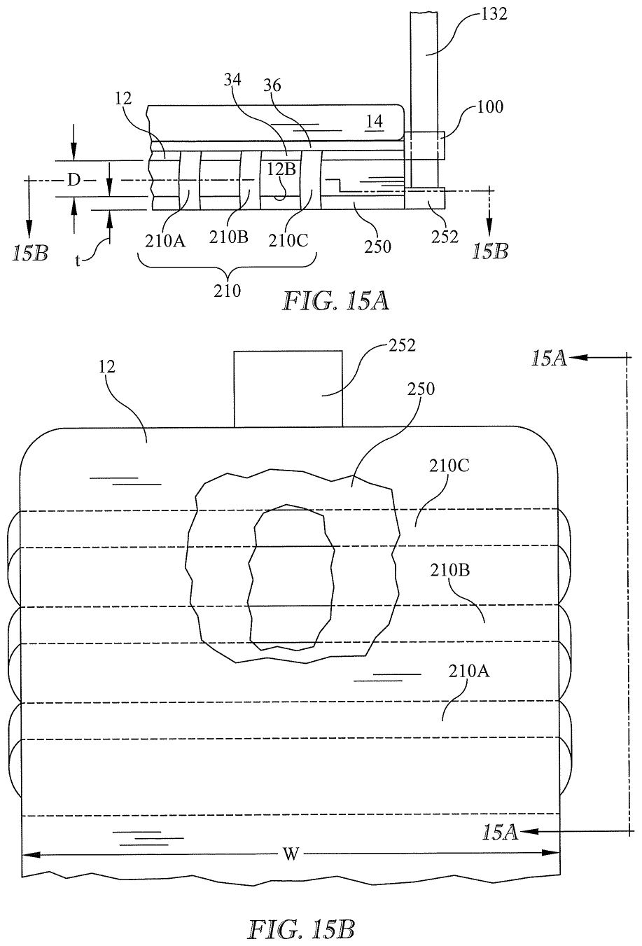

Referring to FIGS. 15A-15B another embodiment of head end mattress support 30 includes a strap assembly 210 attached to or attachable to base plate 34, and a support plate 250. The support plate is not physically attached to the other components that make up this embodiment of the mattress support (e.g. base plate 34, upper plate 36, hinge 38, elevation system 50) nor is its role to support mattress 14. However the support plate includes a second anchor which is used in conjunction with anchor 100 of base plate 34 of head end mattress support 30. In FIG. 15B part of frame 12 is broken away to reveal support plate 250, and part of support plate 250 is broken away to reveal two straps 210A, 210B of strap assembly 210.

Support plate 250 is adapted to be held against the underneath or bottom side 12B of a bed frame 12 by strap assembly 210. The strap assembly is adapted to hold the support plate against the bottom side 12B of bed frame 12. The strap assembly helps keep the head end mattress support, which includes support plate 250, in place laterally and longitudinally. Support plate 250 includes a second anchor 252 for the equipment support. In the embodiments which include the support plate and its second anchor, anchor 100 of base plate 34 is a first anchor. The second anchor may take any of the forms already described for the first anchor (e.g. cup, sleeve). The mast securement arrangements described previously in the context of the first anchor (screws, pins, etc.) are also suitable for the second anchor.

Strap assembly 210 of FIGS. 15A-15B is embodied as a set of three unitary straps, 210A, 210B, 210C. The foregoing description of the embodiment of FIGS. 11A-11B apply to the embodiment of FIGS. 15A-15B with certain exceptions. First, the strap assembly of FIGS. 15A-15B wraps around both bed frame 12 and support plate 250. That is, the strap extends from one side of the base plate, down along the same side of the frame and same side of the support plate, laterally across the bottom side of the support plate, up the opposite lateral side of the support plate and side of the frame, and finally to the other side of the base plate. Second, although each strap has a length which is at least as long as the width W of the base plate, as a practical matter, the length of each strap is at least as long as the width W of the base plate plus two times the depth D of the frame plus two times the thickness t of the support plate (which is relatively thin in comparison to the depth of the frame).

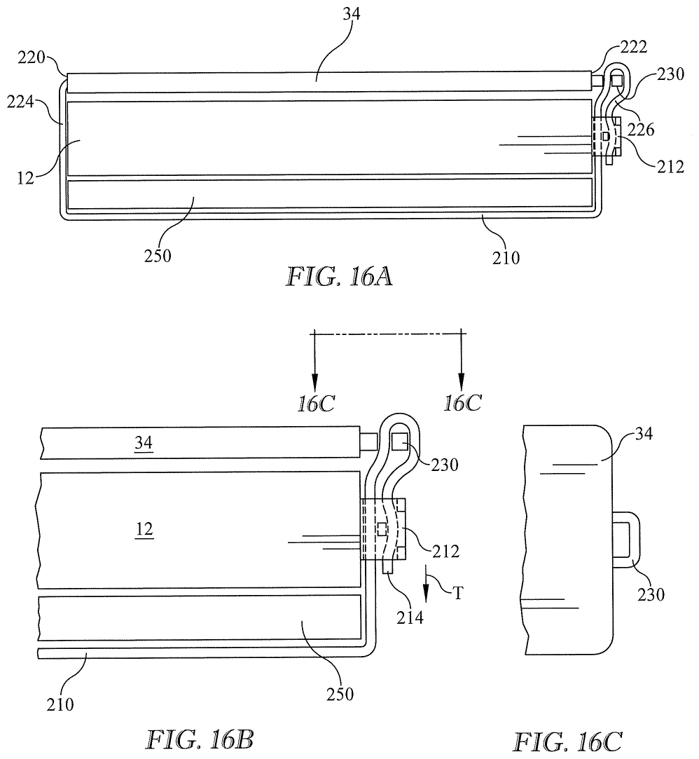

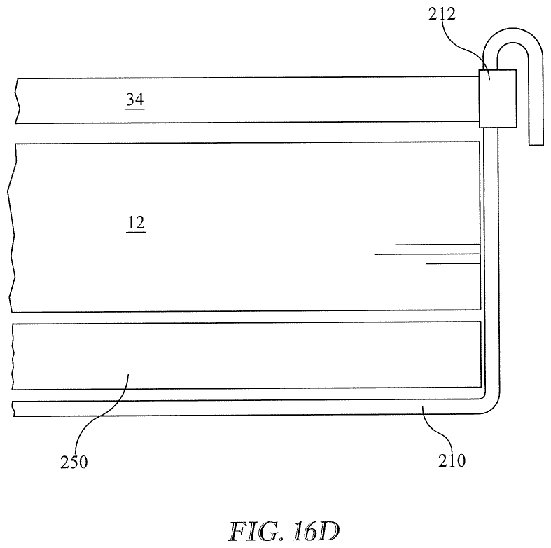

FIGS. 16A-16D show a strap assembly for another embodiment of the head end mattress support. The mattress support of FIGS. 16A-16D is similar to the mattress support of FIGS. 12A-12D but includes support plate component 250. The strap assembly is embodied as a single, unitary strap, and a strap tensioner 212. The strap has a first end 224 attached or attachable to a first lateral side 220 of base plate 34, and a second end 226 attached or attachable to a second lateral side 222 of the base plate at a lashing ring 230. The strap is adapted to extend underneath support plate 250 from the first lateral side of the base plate to the second lateral side of the base plate. The tensioner is in the form of a one-way buckle on the strap. The free end of the strap passes easily through the buckle in a direction T for tightening the strap. The strap cannot easily pass through the buckle in the other direction unless a user intentionally releases the buckle's grip on the strap.

Referring to FIG. 16D, the one-way buckle could be a part of the base plate (in lieu of lashing ring 230) instead of part of the strap.

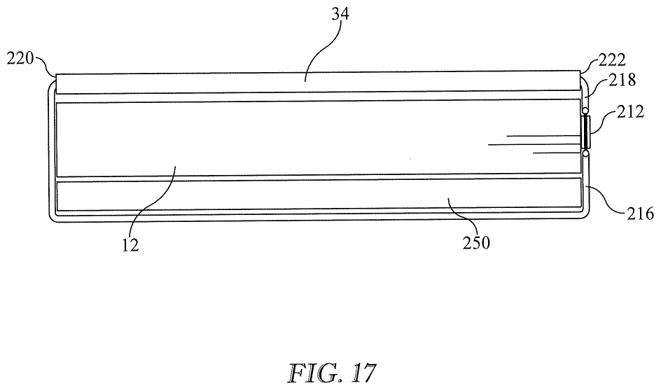

FIG. 17 shows an embodiment in which the strap assembly, once again embodied as a single strap, is a nonunitary strap which includes a first strap segment 216 attached (permanently or removably) or attachable to a first lateral side 220 of base plate 34 and a second strap segment 218 attached (permanently or removably) or attachable to a second lateral side 222 of the base plate. The mattress support of FIG. 17 is similar to the mattress support of FIG. 13 but includes support plate component 250. The strap segments are designed to be in series with each other, i.e. they are designed to be used at substantially the same longitudinal location along the length of the bed. The first strap segment is relatively long, and passes underneath support plate 250. The second strap segment is relatively short and hangs down along the second side of the frame. The tensioner is a turnbuckle 212 which may be a part of the first strap segment or a part of the second strap segment or may be a separate component which is connectable to the strap segments. A user tightens the turnbuckle to tension the strap or untightens the turnbuckle to detension the strap.

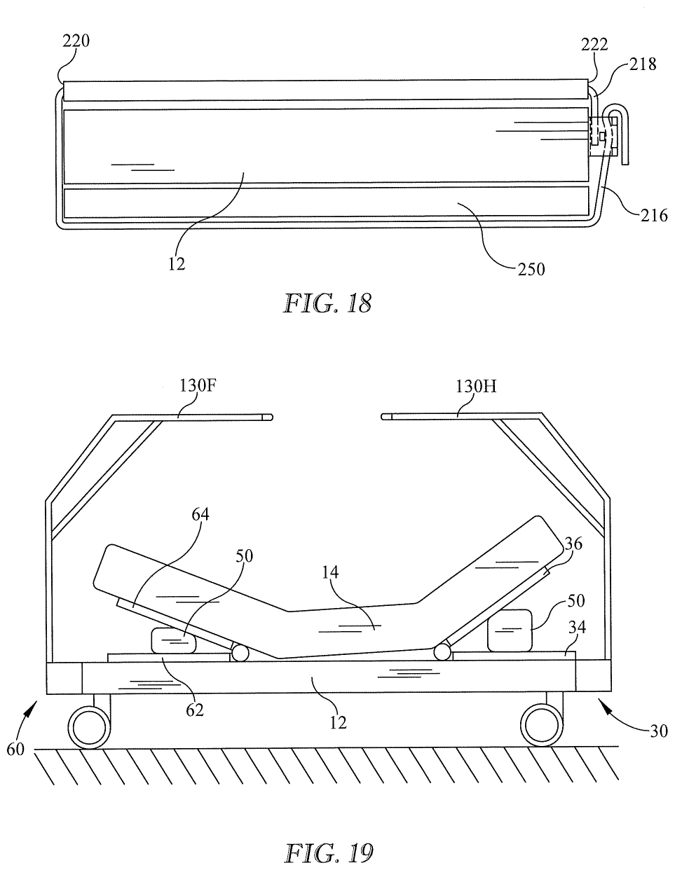

FIG. 18 shows another embodiment in which the strap assembly is embodied as a single nonunitary strap. The mattress support of FIG. 18 is similar to the mattress support of FIG. 14 but includes support plate component 250. The strap includes a first strap segment 216 attached or attachable to a first lateral side 220 of base plate 34, and a second strap segment 218 attached or attachable to a second lateral side 222 of the base plate 34. The bed frame 12 includes a strap segment connector and tensioning feature 236. One example of a suitable feature is the one-way buckle of FIGS. 12B and 12D. The strap segments are adapted to be attached to or attachable to the bed frame, e.g. to connector and tensioning feature 236. A user inserts the free ends 238-1, 238-2 of each strap segment through the connector and tensioning feature to cinch the strap assembly tightly around bed frame 12 and support plate 250. The connector and tensioning feature may be a part of the bed frame or may be an add-on item sold separately.

In the foregoing description the mattress support has been shown and described as a head end mattress support, i.e, a mattress support whose base plate 34 and upper plate 36 are to be installed between the head end of the mattress and the head end of the frame. If the mattress support includes support plate 250, the support plate is to be installed under the head end of the frame. However the mattress support could instead be a foot end mattress support to be installed at the foot end of the bed and could include or not include support plate 250 and second anchor 252. The variations and attributes of the head end mattress support described above apply to a foot end mattress support.

Whether the mattress support is a head end mattress support installed at the head end of the bed or a foot end mattress support installed at the foot end of the bed, the equipment support will be supported only at the head end of the bed or at the foot end of the bed. For example the equipment supports of FIGS. 4A and 5A are supported only at the head end of the bed.

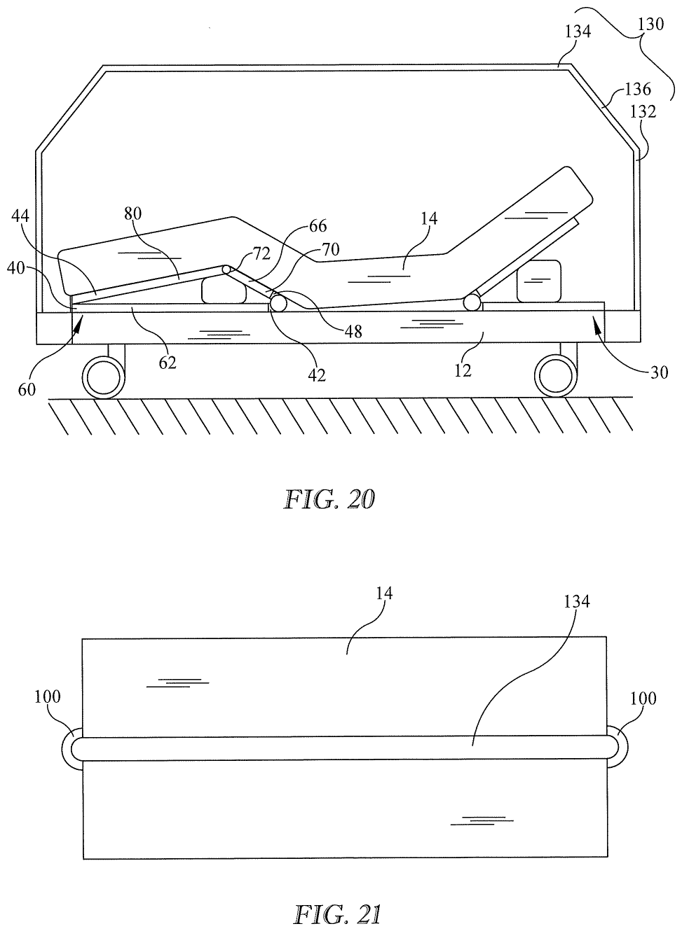

Referring to FIG. 19, another embodiment includes both a head end mattress support 30 and a foot end mattress support 60, each of which is like the mattress support embodiments already described. This “double ended” embodiment will support an equipment support 130H at the head end of the bed and an equipment support 130F at the foot end of the bed, or will support one or more equipment supports that span the length of the bed as seen in FIGS. 20-23. Mattress supports 30, 60 of FIG. 19 each include only a base plate 34 or 62 and upper plate 36 or 64 but either or both could also include a support plate 250 as described in connection with FIGS. 15-18. The various strap arrangements previously described also apply to the embodiment of FIG. 19 and the other embodiments described below.

FIG. 20 shows another embodiment that includes both a head end mattress support 30 and a foot end mattress support 60. Head end mattress support 30 is like the mattress support described above. Foot end mattress support 60 differs from the head end mattress support 30, and from the foot end mattress support of FIG. 19, in that its upper plate 64 is an assembly comprised of a head plate 66 and a foot plate 80 hinged to the head plate as described in connection with FIGS. 1-2. Nevertheless, base plate 34, like the base plate previously described in this specification, has a free end 40 and a hinged end 42, and upper plate assembly 64 has a free end 44 and a hinged end 48 connected to the hinged end of the base plate by a hinge.

FIG. 21 is a plan view of an embodiment having both a head end mattress support and a foot end mattress support, each with an anchor 100 as already described. A support plate with a second anchor may also be provided at the head end and/or foot end. A full length equipment support 130 having a single beam 134 extends the entire distance between the head end and foot end anchors.

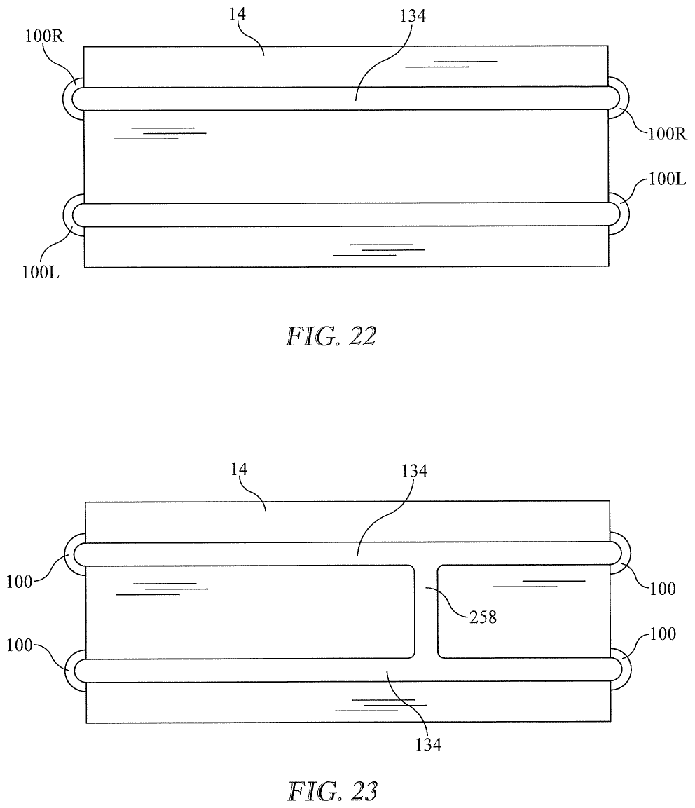

FIG. 22 is a plan view similar to that of FIG. 21 in which a multiplicity (two in the illustration) of single beam equipment supports each extend between respective head end and foot end anchors. A left side equipment support extends between left side head end and foot end anchors 100L. A right side equipment support extends between right side head end and foot end anchors 100R.

FIG. 23 a plan view similar to that of FIGS. 21 and 22. The equipment support of FIG. 22 includes two beams 134 and four masts, one mast anchored in one of four anchors 100, and in second anchors 250 if desired. A crossbar 258 extends between the beams.

The purpose of the mattress support described herein is to enable a residential bed to be converted or upgraded to a configuration that includes functionalities typically or exclusively found only in specially designed hospital beds. The components necessary to carry out the conversion may be sold individually, or as a kit or component suite, to customers who wish to convert their residential beds.

Accordingly, an upgrade or conversion kit may include a mattress support (e.g. 30, 60) and an equipment support (e.g. 130, 130H, 130L). The mattress support and equipment support are designed to work together. The mattress support is adapted to support the equipment support, i.e. to bear its weight and the weight of any equipment supported by the equipment support and/or any portion of the patient's weight which is borne by the equipment support. The mattress support is also physically compatible with the equipment support. That is, the mattress support includes a quantity of anchors compatible with the requirements of the equipment support and having a geometry and any other attributes necessary to accommodate the equipment support. Similarly, the equipment support is adapted to be supported by the mattress support. That is, the equipment support is structurally and physically designed to fit together with and be borne by the mattress support.

One embodiment of a kit includes both the base plate/upper plate component 34/36 or 62/64 as well as the support plate component 250. Another embodiment does not include the support plate component. Kit embodiments may also include strap assemblies 210. Kit embodiments may also include a strap tensioner 212, either as an element of the assembly or as a separate component. Some kit embodiments may also include a combination attachment/tensioner 236.

As can be appreciated from the foregoing, the mattress support with anchor 100, either alone or accompanied by support plate 250 and a second anchor 252, and equipment support 130, adds to a residential bed a functionality heretofore found only in specially designed hospital beds, namely an equipment support and a mattress support adapted to support the equipment support. A patient who requires an equipment support, but who does not need to be hospitalized, can therefore achieve the functionality in his residential bed at a modest cost.

Although this disclosure refers to specific embodiments, it will be understood by those skilled in the art that various changes in form and detail may be made without departing from the subject matter set forth in the accompanying claims.

We claim:

1. A mattress support comprising:
a base plate having a free end and a hinged end;
an upper plate having a free end and a hinged end, the hinged end of the upper plate connected to the hinged end of the base plate by a hinge; and
an equipment support anchor at the free end of the base plate.

2. The mattress support of claim 1 wherein the mattress support is adapted to be inserted between a mattress and a frame of a bed so that, when so inserted, the anchor is accessible from a longitudinal end of the bed.

3. The mattress support of claim 1 wherein the base plate and upper plate are adapted to be installed between a mattress and a frame of a bed so that, when so installed, the anchor projects longitudinally beyond the longitudinal end of the mattress.

4. The mattress support of claim 1 including:
a strap assembly comprised of a unitary strap attached or attachable to a first lateral side of the base plate and attached or attachable to a second lateral side of the base plate, the length of the strap assembly being at least as long as the width of the base plate.

5. The mattress support of claim 4 including a tensioner.

6. The mattress support of claim 1 including:
a strap assembly comprised of a unitary strap having a first end attached or attachable to a first lateral side of the base plate, and a second end attached or attachable to a second lateral side of the base plate, the strap adapted to extend from the first lateral side of the base plate, laterally across the bottom side of a bed frame and to the second lateral side of the base plate.

7. The mattress support of claim 1 including:
a strap assembly comprised of a first strap segment attached or attachable to a first lateral side of the base plate, and a second strap segment attached or attachable to a second lateral side of the base plate, the strap segments adapted to be attached to or attachable to a frame of a bed.

8. The mattress support of claim 1 including:
a strap assembly comprised of a first strap segment attached or attachable to a first lateral side of the base plate, and a second strap segment attached or attachable to a second lateral side of the base plate, the strap segments adapted to be connected to each other.

9. The mattress support of claim 8 including a tensioner and wherein the straps are adapted to be connected to each other by the tensioner.

10. The mattress support of claim 1 including:
a strap assembly attached to or attachable to the base plate; and
a support plate adapted to be held against the bottom of a bed frame by the strap assembly, the support plate including a second equipment support anchor.

11. The mattress support of claim 10 wherein the strap assembly is attached or attachable to a first lateral side of the base plate and attached or attachable to a second lateral side of the base plate, the length of the strap assembly being at least as long as the width of the base plate.

12. The mattress support of claim 10 including:
a strap assembly comprised of a unitary strap having a first end attached or attachable to a first lateral side of the base plate, and a second end attached or attachable to a second lateral side of the base plate, the strap adapted to extend from the first lateral side of the base plate, laterally across the bottom side of the support plate and to the second lateral side of the base plate.

13. The mattress support of claim 10 including:
a strap assembly comprised of a first strap segment attached or attachable to a first lateral side of the base plate, and a second strap segment attached or attachable to a second lateral side of the base plate, the strap segments adapted to be attached to or attachable to a frame of a bed.

14. The mattress support of claim 10 including:
a strap assembly comprised of a first strap segment attached or attachable to a first lateral side of the base plate, and a second strap segment attached or attachable to a second lateral side of the base plate, the strap segments adapted to be connected to each other.

15. An upgrade kit comprising:
a mattress support; and
an equipment support;
the mattress support adapted to support the equipment support and the equipment support adapted to be supported by the mattress support.

16. The kit of claim 15 wherein the mattress support comprises a base plate and an upper plate hinged to the base plate, the base plate having an anchor at a non-hinged end thereof, the anchor adapted to support the equipment support.

17-20. (canceled)

21. The kit of claim 16 wherein the base plate and upper plate are adapted to be installed between a mattress and a frame of a bed so that, when so installed, the anchor projects longitudinally beyond the longitudinal end of the mattress.

22-24. (canceled)

25. The kit of claim 15 including:
a strap assembly comprised of a first strap segment attached or attachable to a first lateral side of the base plate, and a second strap segment attached or attachable to a second lateral side of the base plate, the strap segments adapted to be attached to or attachable to a frame of a bed.

26. The kit of claim 15 including:
a strap assembly comprised of a first strap segment attached or attachable to a first lateral side of the base plate, and a second strap segment attached or attachable to a second lateral side of the base plate, the strap segments adapted to be connected to each other.

27. The kit of claim 15 wherein the mattress support is a head end mattress support adapted to support a head end of the equipment support and the kit also includes a foot end mattress support adapted to support a foot end of the equipment support.
